(19) United States
(12) Patent Application Publication
(10) Pub. No.: US 2016/0262963 A1
(43) Pub. Date: Sep. 15, 2016

(54) SUSPENSION SYSTEM AND METHOD FOR WHEELCHAIRS

(71) Applicant: QUADSHOX LLC, FORT COLLINS, CO (US)

(72) Inventors: John Morris, Fort Collins, CO (US); Josh Gladfelter, Fort Collins, CO (US); Garret Ehrick, Fort Collins, CO (US)

(21) Appl. No.: 15/066,899

(22) Filed: Mar. 10, 2016

Related U.S. Application Data
(60) Provisional application No. 62/131,158, filed on Mar. 10, 2015.

(51) Int. Cl. A61G 5/10

(52) U.S. Cl. CPC A61G 5/10; A61G 2005/1078

(57) ABSTRACT

A suspension method and apparatus using a mount, a shock absorber and a moment arm to mitigate stresses and impacts to wheelchair bound individuals. A moment arm attaches to the axle and frame of a wheelchair. A shock absorber supplies suspension between the moment arm and the frame via a mount attached to the frame.

### BACKGROUND OF THE INVENTION

There are presently almost four million individuals in the United States that spend all day in a wheelchair. In that regard, high-level quadriplegics and other individuals with similar functional ability generally also use a manual wheelchair. A common type of manual wheel chair is a “tilt-in-space” chair. A tilt-in-space wheelchair generally provides a change in position for clients who cannot independently shift their body weight. When an individual is unable to independently shift their weight or change positions while seated in an upright position they are at a very high risk for skin breakdown and sitting tolerance is comprised due to this inability to redistribute pressure. A tilt-in-space chair provides a means for weight shifts and position changes. A tilt-in-space chair reduces the risk of skin breakdown by redistributing pressure from the pelvis to the back. A tilt-in-space provides a safe and easy way for a caregiver to provide a weight shift for the end user.

While sitting in the upright position, gravity pushes down on the body. If muscle strength or overall endurance is compromised, clients will be unable to maintain proper upright posture, which can lead to postural deviations such as a posterior pelvic tilt, thoracic kyphosis, and lateral lean.

Manual chairs may be attendant propelled. An attendant propelled chair is one that requires an attendant to propel the chair due to the limitations of the person in the chair. A chair may also be one that is propelled by the person in the chair. Many tilt-in-space chairs are attendant propelled. Such self-propulsion may be performed by the person using the wheels of the chair to move the chair forward or backward. Also, a self-propelled chair may be propelled by an electromechanical means operated by the person in the chair. A tilt-in-space chair may also be referred to as a rotation-in-space chair.

### SUMMARY OF THE INVENTION

An embodiment of the invention may therefore comprise a method for providing suspension to a wheelchair, the method comprising attaching a mount to a frame support of the wheelchair, attaching a shock absorber to the mount, placing at least one moment arm on an axle of the wheelchair, attaching the at least one moment arm to the frame support of the wheelchair, and attaching the shock absorber to the at least one moment arm.

An embodiment of the invention may further comprise a suspension for a wheelchair, the suspension comprising a mount, wherein the mount is attachable to a frame support of the wheelchair, a shock absorber, wherein the shock absorber is attachable to the mount, and at least one moment arm, wherein the at least one moment arm is attachable to an axle of the wheelchair, is attachable to the frame support, and is attachable to the shock absorber.

### BRIEF DESCRIPTION OF THE DRAWINGS

FIG. 1 shows a wheelchair frame and a suspension.

FIG. 2 shows a wheelchair wheel and a suspension.

FIG. 3 shows a suspension with a frame support and an axle.

FIG. 4 shows an exploded view of a suspension.

FIG. 5 shows an alternate mount.

FIG. 6 shows a downward mount spring connection.

FIG. 7 shows a suspension with a frame support and an axle.

### DETAILED DESCRIPTION OF THE EMBODIMENTS

Manual wheelchair designs generally mount its rear wheels on an axle. Further, attendant propelled, tilt-in-space wheelchairs used in support of spinal cord, other injuries and predisposition genetic disabilities generally have at least one axle, or partial axles provided for individual wheels. For example, a Quickie Iris model wheelchair and the Invacare Solara model wheelchair are chairs that have at least one axle, or partial axles provided for individual wheels.

Wheelchair designs that have a rear axle wheel mount may further include a rail-like rolling frame that is positioned substantially perpendicularly to the axle. The rolling frame may include a number of passages or openings positioned at regular distances along its length. Such passages may be sized to allow a bolt to pass through, thereby allowing for nuts and bolts attachments.

Many manual wheelchair designs may not include a suspension. Individuals in wheelchairs that lack suspension may experience pain or discomfort when traversing across uneven surfaces. A suspension on a manual wheelchair may provide life enhancing opportunities.

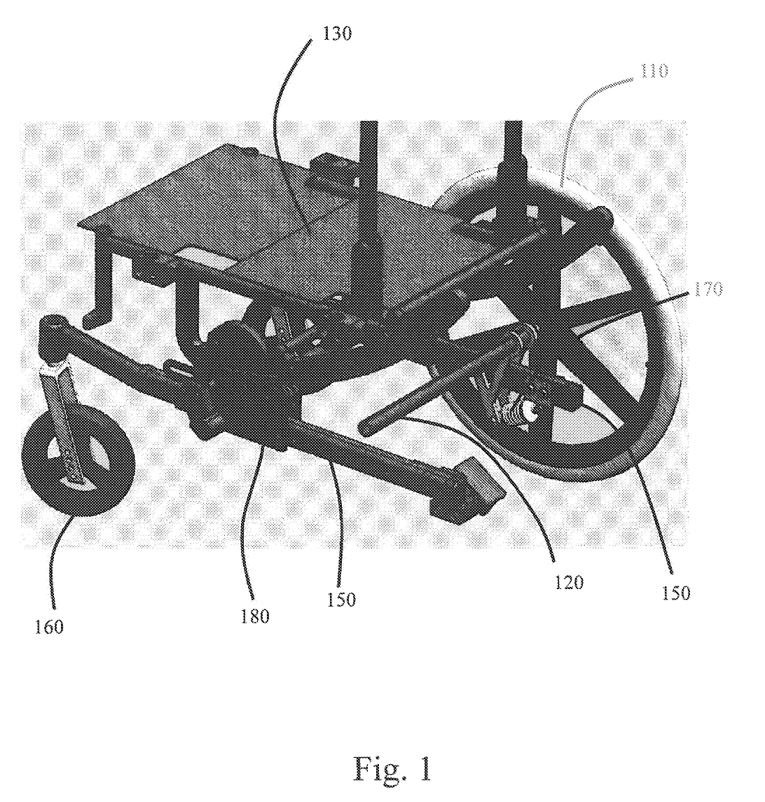

FIG. 1 shows a wheelchair frame and a suspension. In the wheelchair and suspension shown in FIG. 1, only a portion of the wheelchair and suspension is shown. FIG. 1 shows a rear wheel 110 connected to an axle 120. A wheelchair frame 130 connects to frame supports 150. A front wheel 160 connects to the wheelchair frame support 150. A suspension 170 is shown connected to the frame supports 150 and the axle 120. Those skilled in the art will understand that only a portion of the wheelchair is shown. A seat, for instance, is not shown in FIG. 1, as well as the other rear wheel. A rotational, or tilt, mechanism 180 is shown connecting the wheelchair frame to the frame supports. The rotational, or tilt, mechanism 180 allows the wheelchair frame 130 to rotate and provide physical comfort to a client.

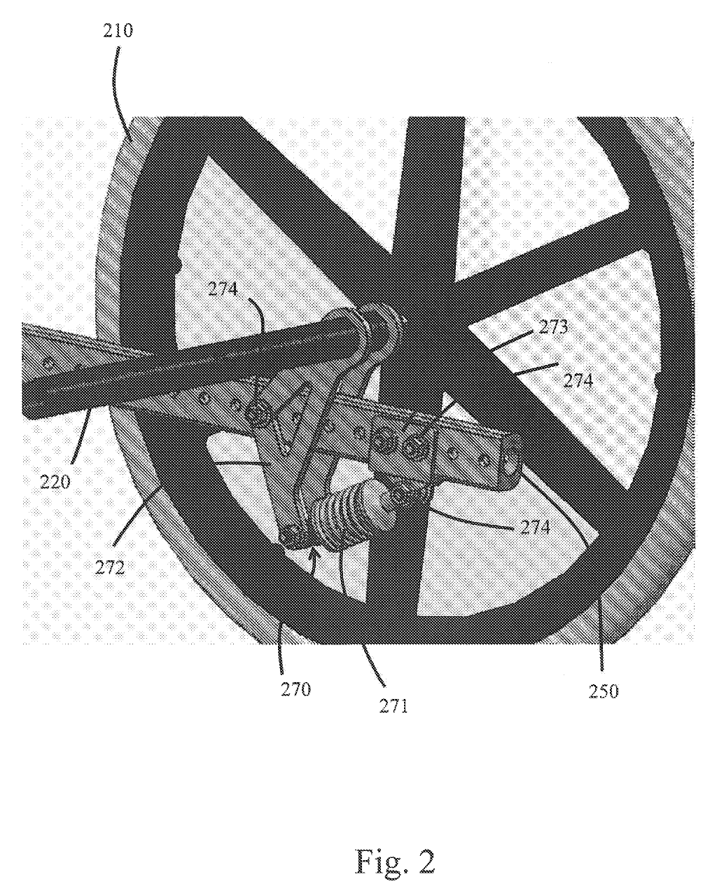

FIG. 2 shows a wheelchair wheel and a suspension. FIG. 2 is a close up view of the suspension 170, wheel 110 and axle 120 of FIG. 1. FIG. 2 shows a wheel 210, an axle 220, a frame support 250 and a suspension 270. The suspension is comprised of a mount 273, a pair of moment arms 272 and a shock absorber with spring 271. The mount 273 connects to the frame support 250. The mount 273 is shown connected to the frame support with a pair of nuts and bolts 274. The shock absorber with spring 271 is shown connected to a lower connector portion of the mount 273. The shock absorber with spring 271 connects to the moment arm 272. The moment arm 272 connects to the frame support 250 and to the axle 220. As forces act on the wheel 210 during movement of the wheelchair, the moment arm 272 will rotate about the connection to the frame support 250. The shock absorber with spring 271 provides resistive force but allows the wheelchair to move with reduces jarring movements. Those skilled in the art will understand that the pair of moment arms 272 may be a singular moment arm.

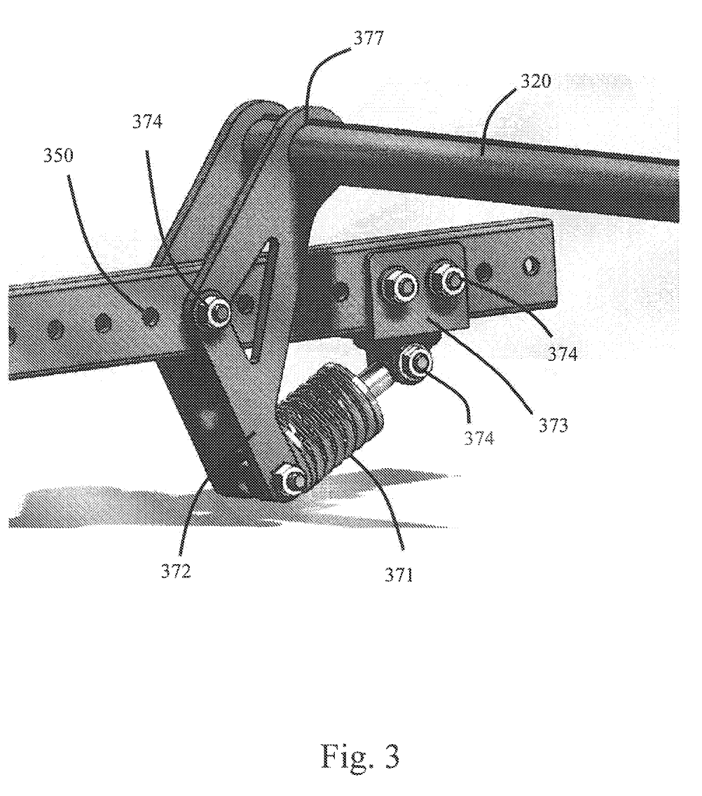

FIG. 3 shows a suspension with a frame support and an axle. In FIG. 3, extraneous components of the wheelchair, such as the wheel and frame, are not shown to remove visual obstructions and provide a clear view of the components of a wheelchair suspension. A mount 373 is connected to a frame support 350. The mount 373 connects to a shock absorber with spring 371, which connects to at least one moment arm 372. The moment arm 372 may be one of two or more moment arms. FIG. 3 shows a pair of moment arms 372. The shock absorber with spring in FIG. 3 may be any type of shock absorber with spring that provides suspension effects. The spring in the shock absorber and spring assembly may be adjusted to accommodate different weights of the occupants of the chair. The spring component can be an extension spring. The spring may be a torsion spring. The spring may be a tapered spring. Those skilled in the art will understand the various types of springs, and shock absorbers, and connection arrangements that may be used to provide suspension effects to a wheelchair.

As shown in FIG. 3, the shock absorber with spring 371 may be attached to the two moment arms 372 that have been positioned on opposite sides of the frame support 350. As discussed, it is understood that a single moment arm 372 may be utilized in the invention. The moment arms 372 may be attached to the frame support 350, as well as attached to the axle 320 of the wheelchair. The moment arm 372 has a first opening 377 configured to encircle around the rear axle 320 of the wheelchair, a second opening for a bolts and nuts attachment to the frame support and a third opening for bolts and nuts attachment to the shock absorber with spring 371. The moment arm 372 may have an alternate configuration for attaching to the axle. For instance, the moment arm 372 may have an opening that does not fully encircle the axle 320 but which allows the moment arm, during installation, to be placed over the axle without removing the axle and then is held in place firmly once the moment arm 372 is attached to the frame support 373 and the shock absorber with spring 371.

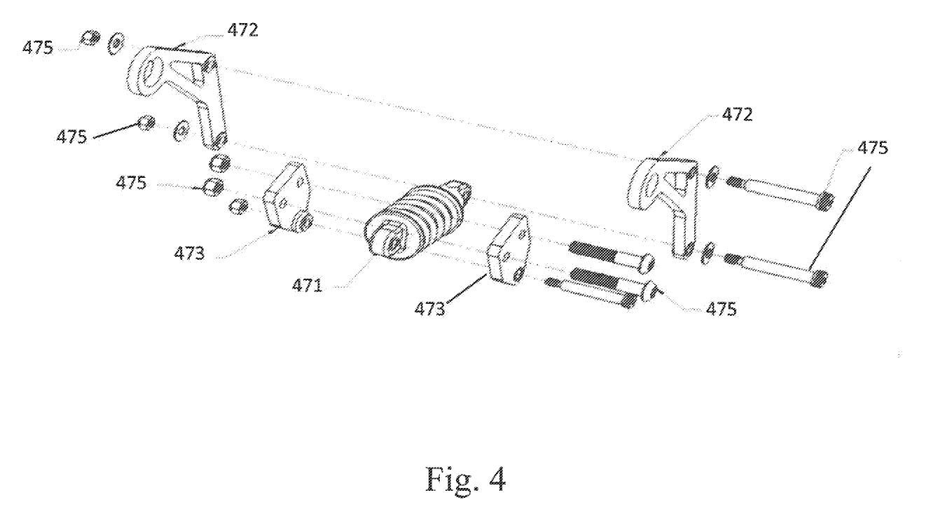

FIG. 4 shows an exploded view of a suspension. The suspension 400 comprises a shock absorber with spring 471, a pair of moment arms 472, and a mount 473. The moment arms 472 connect to an axle (not shown in FIG. 4) and to the shock absorber with spring 471. The moment arm additionally connects to a frame support (not shown in FIG. 4). The shock absorber with spring 471 also connects to the mount 473. The mount 473 shown in FIG. 4 comprises a pair of plates. Each of the plates will attach to the frame support. As shown, the mounts 473 comprise the plates where each of the plates has a plurality of holes which are configured to align with holes in the frame support and which enables a bolt and nut to attach the mount 473 to the frame support. As shown in FIG. 4, the mount attaches to the frame support on two opposing sides of the frame support. A nut and bolt configuration 475 may be used to affix the mount 473 to a frame support. Two moment arms 472 are shown in FIG. 4. It is understood that one moment arm 472 may be used to provide connection to a frame support and to an axle. The two moment arms 472 connect to a frame support with a nut and bolt 475 arrangement. The two moment arms 472 each have a hole configured to align with holes in a frame support and which enable the bolt and nut 475 to attach the moment arms 472 to the frame support. The shock absorber with spring 471 attaches to the mount 473 utilizing a bolt and nut arrangement 475. A hole toward one end of the shock absorber with spring 471 aligns with holes in the mount 473 to allow the bolt and nut to connect the spring 471 to the mount 473. A second hole in the shock absorber with spring 471 that is located toward the other end of the shock absorber with spring 471 allows a bolt and nut arrangement 475 to connect the shock absorber with spring 471 to the moment arms 472. The second hole aligns with holes in the moments arms 472 to allow the shock absorber with spring 471 to connect to the moment arms 472.

The bolt and shock absorber with spring arrangements 475 shown in FIG. 4 may comprise a washer or other element to allow easy connections and security to any resulting connection. Other arrangements may also be utilized. For instance, a pin type connection that allows a pin to slide into the holes and then be secured on one end with a connector that disallows the pin to be removed from the hole. In two dimensions, a pin connection restrains two translation degrees of freedom but does not restrain rotation. Those skilled in the art will understand various other methods of connection the shock absorber with spring to the moment arms and mounts, and the moment arms and mount to a frame support. The invention herein described is not limited to any particular means of connecting the shock absorber with spring, mounts or moment arms.

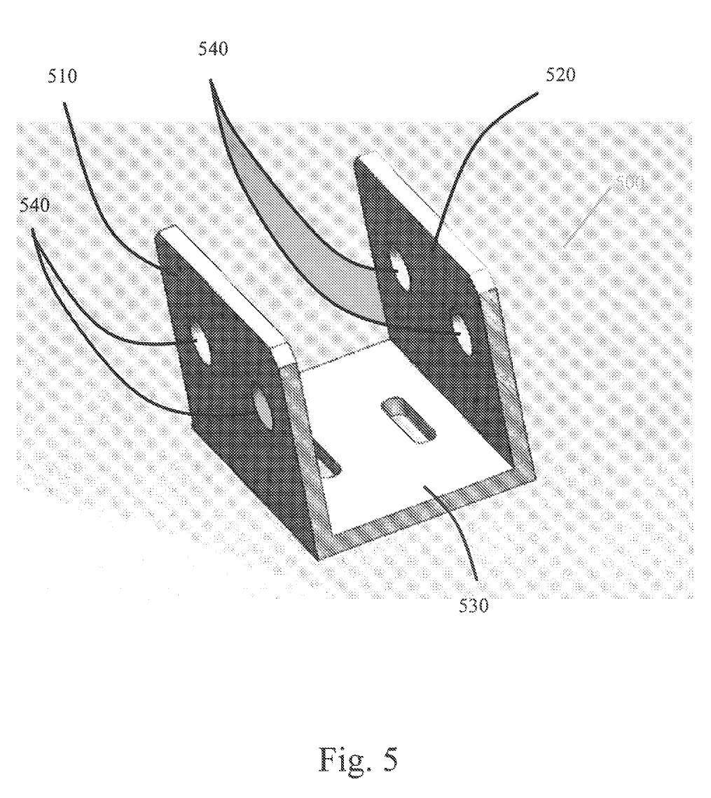

FIG. 5 shows an alternate mount. The mount 500 may be shaped to fit on three sides of a frame support. The mount could have a first side 510, a second side 520 and an underside 530. The term underside is not meant to indicate that the side is required to be under anything. The mount may also be shaped to fit on 2 sides of a frame support. The first side 510 and the second side 520 are opposite each other and the underside 530 could provide an additional—connection between the first side 510 and the second side 520. The first side 510 and the second side 520 may have openings that align with each other and that will align with holes or openings in a frame support that allow for bolts and nuts attachments.

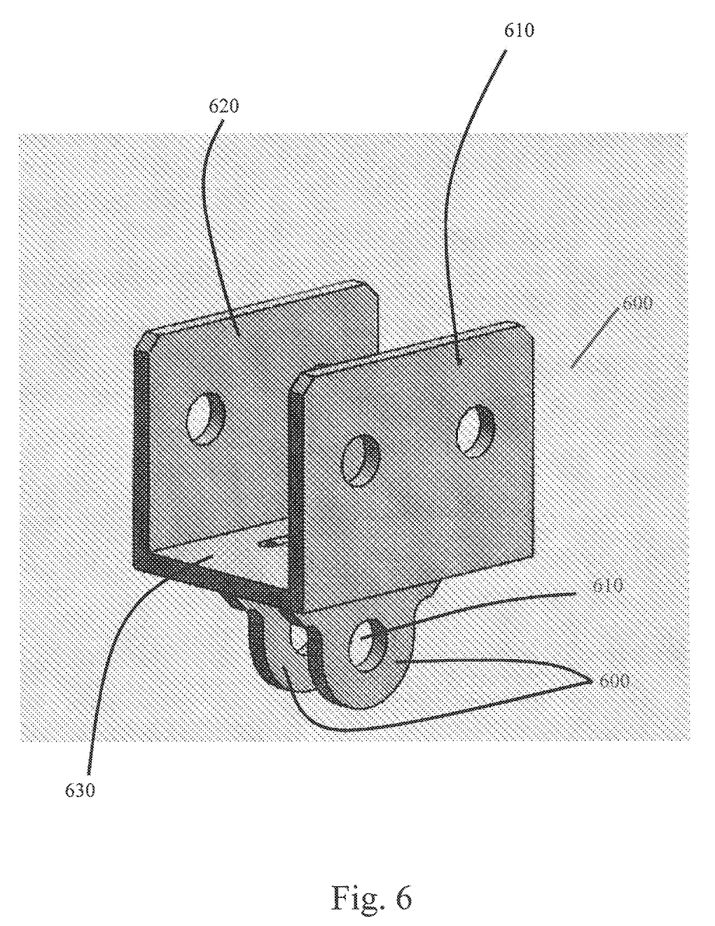

FIG. 6 shows a downward mounted shock absorber with spring connection. The mount of FIG. 5 may further include a component portion 600 that protrudes downwardly from the mount 500. The portion component 600 may have an opening 610 that is designed to align with an opening of a shock absorber with spring (not shown in FIG. 6). A bolts and nuts attachment may be used to attach a shock absorber with spring at one end to the portion component 600 using the aligned openings. FIG. 6 shows two component portions 600 suspended from the underside 530 of the mount 500. A single component portion 610 may be used and the side of the shock absorber with spring that attaches to the mount 500 may be adapted to attach to the single component portion 610.

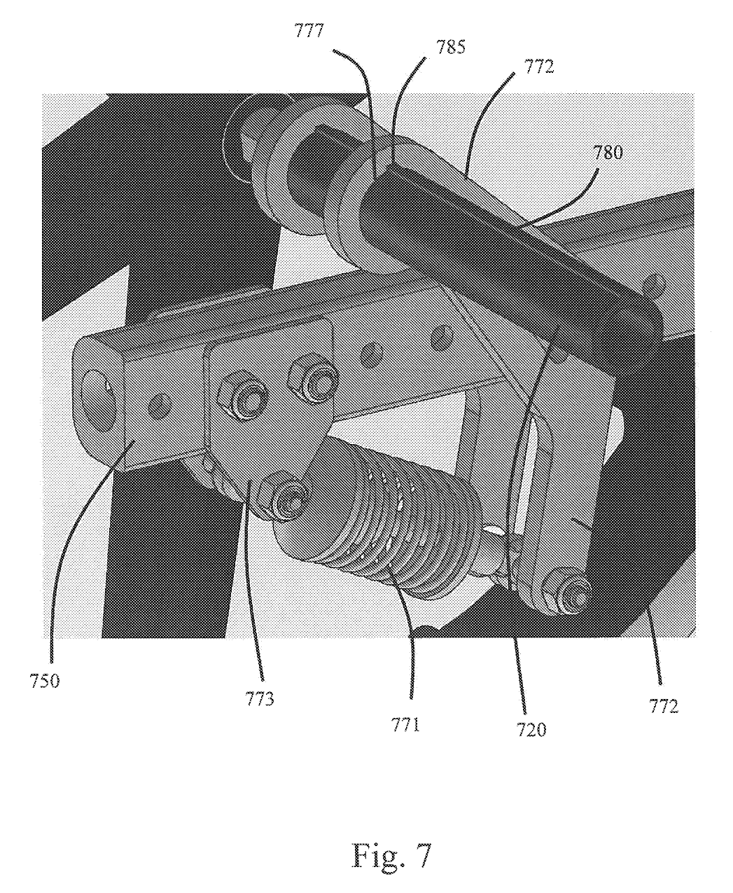

FIG. 7 shows a suspension with a frame support and an axle. In FIG. 7, extraneous components of the wheelchair, such as the wheel and frame, are not shown to remove visual obstructions and provide a clear view of the components of a wheelchair suspension. A mount 773 is connected to a frame support 750. The mount 773 connects to a shock absorber with spring 771, which connects to at least one moment arm 772. The moment arm 772 may be one of two or more moment arms. FIG. 7 shows a pair of moment arms 772. The shock absorber with spring in FIG. 7 may be any type of shock absorber with spring that provides suspension effects. The spring in the shock absorber 771 and spring assembly may be adjusted to accommodate different weights of the occupants of the chair. The spring component can be an extension spring, or any other type of spring or shock absorber. Those skilled in the art will understand the various types of springs, and shock absorbers, and connection arrangements that may be used to provide suspension effects to a wheelchair.

As shown in FIG. 7, the shock absorber with spring 771 may be attached to the two moment arms 772 that have been positioned on opposite sides of the frame support 750. As discussed, it is understood that a single moment arm 772 may be utilized in the invention. The moment arms 772 may be attached to the frame support 750, as well as attached to the axle 720 of the wheelchair. The moment arm 772 has a first opening 777 configured to encircle around the rear axle 720 of the wheelchair, a second opening for a bolts and nuts attachment to the frame support and a third opening for bolts and nuts attachment to the shock absorber with spring 771.

In FIG. 7, the axle has a stop 780. The moment arm 772 has a corresponding stop accepting cutout 785. The first opening 777 will fit over the axle 720 wherein the cutout will fit the stop. The stop may be referred to as a stop spindle, an anti-rotational device or protrusion. The stop, with the cutout fitted over the stop, prevents the moment arm 772 from rotating in relation to the axle when force is applied. Although the stop in FIG. 7 is shown as a protrusion from the axle, it is understood that other forms of stops may be used. For instance, the axle may comprise a notch wherein the moment arm has a protrusion from the first opening that fits into the notch. The stop of the axle is shown as a rectangular protrusion. It is understood that the stop may be shaped in any manner that allows stoppage of rotation of the moment arm. For instance, the stop may be dome shaped or triangular. Those skilled in the art will understand the different shapes that the stop may assume.

The presently described suspension is described in regard to a particular type of axle and frame organization of a wheel chair. For example, in FIG. 3, as well as other figures showing an axle, the axle is above the frame support. It is understood that in certain wheelchairs the axle may reside below the frame support. As such, the suspension of the invention would be likewise flipped and the suspension would work equally well for the wheelchair. The mounts, shock absorber with spring, and moment arms described herein may be modified to accommodate different sizes, shapes, and configurations of the various wheelchair components or corresponding components.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for providing suspension to a wheelchair, said method comprising:
attaching a mount to a frame support of said wheelchair;
attaching a shock absorber to said mount;
placing at least one moment arm on an axle of said wheelchair, attaching said at least one moment arm to said frame support of said wheelchair; and
attaching said shock absorber to said at least one moment arm.

2. The method of claim 1, wherein said mount comprises a u-shaped mount comprising a first side, a second side, and a connecting side wherein said first side and said second side have openings that align with openings in said frame support.

3. The method of claim 1, wherein said mount comprises a pair of mount plates wherein said pair of mount plates are mounted on said frame in opposition to each other.

4. The method of claim 1, wherein said mount comprises a first plate and a second plate wherein said first plate and said second plate have openings that align with openings in said frame support.

5. The method of claim 1, wherein said at least one moment arm comprises two moment arms wherein said two moment arms are placeable on opposite sides of said frame support of said wheelchair and said two moment arms have openings that align with openings in said frame support.

6. The method of claim 1, wherein said at least one moment arm has a first opening configured to encircle said axle.

7. The method of claim 5, wherein said moment arm further has second opening for attachment to said frame support and a third opening for attachment to said spring.

8. The method of claim 1, wherein said axle comprises a stop and wherein said at least one moment arm comprises a notch enabled to accept said stop during said attaching said at least one moment arm to said frame support of said wheelchair.

9. A suspension for a wheelchair, said suspension comprising:
a mount, wherein said mount is attachable to a frame support of said wheelchair;
a shock absorber, wherein said shock absorber is attachable to said mount; and
at least one moment arm, wherein said at least one moment arm is attachable to an axle of said wheelchair, is attachable to said frame support, and is attachable to said shock absorber.

10. The suspension of claim 7, wherein said mount comprises a u-shaped mount comprising a first -side, a second side, and a connecting side wherein said first side and said second side have openings that align with openings in said frame support.

11. The suspension of claim 7, wherein said mount comprises a pair of mount plates wherein said pair of mount plates are mounted on said frame in opposition to each other.

12. The suspension of claim 7, wherein said mount comprises a first plate and a second plate wherein said first plate and said second plate have openings that align with openings in said frame support.

13. The suspension of claim 7, wherein said at least one moment arm comprises two moment arms wherein said two moment arms are placeable on opposite sides of said frame support of said wheelchair and said two moment arms have openings that align with openings in said frame support.

14. The suspension of claim 7, wherein said at least one moment arm has a first opening configured to encircle said axle.

15. The suspension of claim 11, wherein said at least one moment arm further has a second opening for attachment to said frame support and a third opening for attachment to said shock absorber.

16. The suspension of claim 9, wherein said axle comprises a stop and wherein said at least one moment arm comprises a notch enabled to accept said stop when said mount is attached to said axle.
